(19) United States
(12) Patent Application Publication
(10) Pub. No.: US 2015/0302504 A1
(43) Pub. Date: Oct. 22, 2015

(54) SYSTEM FOR SELECTING A SURFBOARD

(71) Applicant: YEW REPUBLIC PTY LTD, Brisbane, Queensland (AU)

(72) Inventor: Ryan Willem Mets, Brisbane (AU)

(73) Assignee: Yew Republic Pty Ltd, Palm Beach, QLD (AU)

(21) Appl. No.: 14/441,448

(22) PCT Filed: Oct. 31, 2013
(86) PCT No.: PCT/AU2013/001259

§ 371 Date: May 7, 2015

(30) Foreign Application Priority Data
Nov. 12, 2012 (AU) 2012904923

(51) Int. Cl. G06Q 30/06

(52) U.S. Cl. CPC G06Q 30/0627; G06Q 30/0621

(57) ABSTRACT

The present invention is directed to a system for selecting a surfboard for a user. The system includes data receiving means for receiving user information from the user, determining means for determining surfboard size information using the received user information, and display data generating means being configured to generate display data for displaying one or more surfboard representations corresponding to the determined surfboard size information for selection by the user.

### TECHNICAL FIELD

The present invention relates to a system for selecting a surfboard for a user.

### BACKGROUND ART

Surfboards are currently available in many different types, shapes, sizes, materials, designs and brands. A surfboard may therefore be selected based on, for example, the weight, height and skill/ability of the surfer.

Conventionally, surfers may have to visit a number of different stores before a suitable surfboard is located for purchase. In cases where the desired surfboard is not available, the surfer may have to compromise by purchasing a less compatible surfboard.

In more recent times, online systems have been developed to enable surfers to customise and purchase their surfboards on the Internet. One such online system is described in US patent application no. 2008/0147512. However, such systems can be overwhelming and difficult to use for a customer, especially a customer with little or no surfing experience.

The present invention is directed to a system for selecting a surfboard for a rider, which may at least partially overcome at least one of the abovementioned disadvantages or provide the consumer with a useful or commercial choice.

It will be clearly understood that, if a prior art publication is referred to herein, this reference does not constitute an admission that the publication forms part of the common general knowledge in the art in Australia or in any other country.

### SUMMARY OF INVENTION

According to one aspect of the invention, there is provided a system for selecting a surfboard for a user, the system including data receiving means for receiving user information from the user, determining means for determining at least surfboard size information based on the received user information, and display data generating means being configured to generate display, data for displaying one or more surfboard representations corresponding to the determined surfboard size information for selection by the user.

Advantageously, embodiments of the system typically provide a customer with a selection of suitably sized boards and present the selection to the customer in a visually informative manner that allows the customer to make easy comparisons between the boards. The system thereby better engages and guides the customer to continue to proceed in using each step of the system.

The one or more surfboard representations may include one or more surfboard profile representations.

The user information may include personal information in relation to the user's weight, height, feet size, age, fitness level, skill level, surf conditions the number of months/years that the user has been surfing, surfing frequency, surfing/wave location, and/or wave type or shape.

The user information may further include board information from the user. For example, the board information may include desired volume, length, width, thickness, nose width, tail width, centre of buoyancy, surface area, stability, paddle power, speed, materials, construction method, manufacturer/brand, surfboard shaper location, tail shape, fin layout, fin type, surfboard type, wave height, wave shape, rocker, concave, rails, maneuverability, artwork, minimum/maximum length, minimum/maximum volume, minimum/maximum width, minimum/maximum price, glassing, and/or foam density.

The user information may further include user reviews and/or ratings from a user in relation to a previously purchased or used surfboard.

The user information may include mandatory information in which the user must provide before the data processing means will determine the board size information, and optional information in which the user may choose to provide for consideration by the determining means.

The system may allow the user to enter user information via any one or more of the following entry fields: text entry fields, multiple choice selections, drop-down menus and rating scales. The display data generating means may generate display data for displaying a description associated with an entry field.

The board size, shape and design information may include the length, width, thickness and volume/literage, nose width, tail width, centre of buoyancy, surface area, stability, paddle power, drive/speed, technology/materials, construction method, manufacturer/brand, surfboard shaper location, tail shape, fin layout, fin type, surfboard type/category, price, wave height, wave shape, rocker, concave, rails, maneuverability, artwork, glassing and foam density.

The determining means may further determine surfboard shape and surfboard design information based on the received user information.

The determining means may determine a list of suitable surfboard models for the user based on the user information. In particular, the list of suitable surfboard models determined may be adjustable based on the user reviews and/or ratings submitted by various users.

The one or more board profile representations may be ranked according to ranking factors. The ranking factors may include any one or more of level of compatibility, performance, volume range, price range, length range, brand, quality, reviews, popularity, user ratings, eco ratings and availability. One or more ranking factors may be specified by the user.

The display data generating means may be configured to generate display data for temporarily displaying additional corresponding board representations in response to the user moving a cursor over a board profile representation on the user's display device.

The display data generating means may be configured to generate display data for displaying information in relation to the length, width, thickness, volume, fin layout options, prices, board shaper, board model, available stock, reviews, surfboard category, surfboard image and shape outline preview.

The display data generating means may further generate display data for displaying representations of available off-the-rack boards which are ready for purchase.

The system may further include locating means for locating the user and providing information to the user in relation to one or more retailers located close by having a selected off-the-rack board available for purchase.

The system may allow retailers, manufacturers and/or shapers to directly upload and maintain surfboard information in relation to their surfboard models on the system. The determining means may determine the list of suitable surfboard models based on the surfboard information. The display data generating means may generate display data for displaying representations of the surfboard models for selection and purchase by a user. The representations may include profile representations.

Advantageously, a user may select a surfboard model directly from a retailer, manufacturer or shaper's microsite, which is maintained directly by the retailer, manufacturer or shaper, to thereby purchase or customize the selected surfboard model.

The data receiving means may receive one or more user selected board representations for saving in a shortlist database such that the user can revisit the board, representations saved in the shortlist database at any time.

The data receiving means may receive a user selection of a board representation displayed on the user's display device for customisation.

In response to the user selection of the board representation for customisation, the display data generating means may generate further display data for displaying customisation options on the user's display device.

The customisation options may include any one or more of: size options of the board, tail shape options, construction and glassing options, fin layout options, fin type options, art work options, printed or inscribed text.

The customisation options may further allow the user to manually adjust the length, width, thickness, tail shape, nose width, tail width, rail shape, concave and/or rocker of a selected surfboard. Manual adjustments within predetermined measurement ranges may be permitted.

The display data generating means may generate display data for only displaying customisation options, which have been tried and tested and or recommended by a manufacturer or a surfboard shaper.

The display data generating means may generate display data for displaying a temporary text box or visual aid providing an explanation of a customisation option in response to a user moving a cursor over the customisation option on the user's display device.

The display data generating means may further generate display data for displaying surfboard accessories options on the user's display device. The surfboard accessories options may include any one or more of surfboard fin options, tail pad options and leg rope options, surfboard bag options. The surfboard accessories options may be based on the customisation options selected by the user and/or the user information received by the data receiving means. For example, the display data generating means may display suitable fin sizes based on weight of a user. Moreover, the display data generating means may display suitable fin types based on a common wave type at a surf location.

The display data generating means may generate display data for displaying a temporary text box including an explanation of an accessories option in response to a user moving a cursor over the accessories option on the user's display device.

The data receiving means may receive user ratings, reviews and comments in relation to one or more surfboards. The display data generating means may generate display data for displaying the user ratings, reviews and comments in connection with the corresponding surfboards.

The system may further include communication means for allowing the user to communicate with a system administrator, a retailer, manufacturer or shaper. The communication means may include any one or more of: phone, email, SMS messaging, instant messaging and live chat.

The system may further include ordering means for compiling ordering information using one or more of: a user selected surfboard, user selected customisation options and user selected accessories options. The ordering means may transfer the ordering information to a manufacturer or surfboard shaper, surf hardware company or retail partner.

The data receiving means may receive payment, contact and postage information from the user.

According to another aspect of the invention, there is provided a system for selecting a surfboard for a user, the system including data receiving means for receiving user information from the user, determining means for determining at least surfboard size information using the received user information, the surfboard size information including the length, width, thickness and volume of a surfboard, and display data generating means being configured to generate display data for displaying one or more surfboard representations corresponding to the determined surfboard size information for selection by the user.

According to another aspect of the invention, there is provided a system for selecting a surfboard for a user, the system including display data generating means being configured to generate display data for displaying one or more surfboard representations based on user information for selection by the user.

According to a further aspect of the invention, there is provided a method for selecting a surfboard for a user, the method including receiving with computational means, user information from the user, determining with computational means surfboard size information using the received user information, and generating display data with computational means for displaying one or more surfboard representations corresponding to the determined surfboard size information for selection by the user.

According to a further aspect of the invention, there is provided a system for selecting a surfboard for a user, the system including data receiving means for receiving user information from the user, determining means for determining at least surfboard size information based on the received user information.

According to a further aspect of the invention, there is provided a method of selecting a surfboard for a user, the method including,

receiving, with computational means, user information from the user, and

recommending one or more surfboards based on the user information.

The method may include displaying a surfboard summary of each surfboard recommendation.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of a system for selecting a surfboard for a user according to an embodiment of the present invention.

FIGS. 2 to 8 illustrate a number of displays generated by the system of FIG. 1.

FIG. 9 is a flow chart illustrating a method of selecting a surfboard according to an embodiment of the present invention.

### DESCRIPTION OF EMBODIMENTS

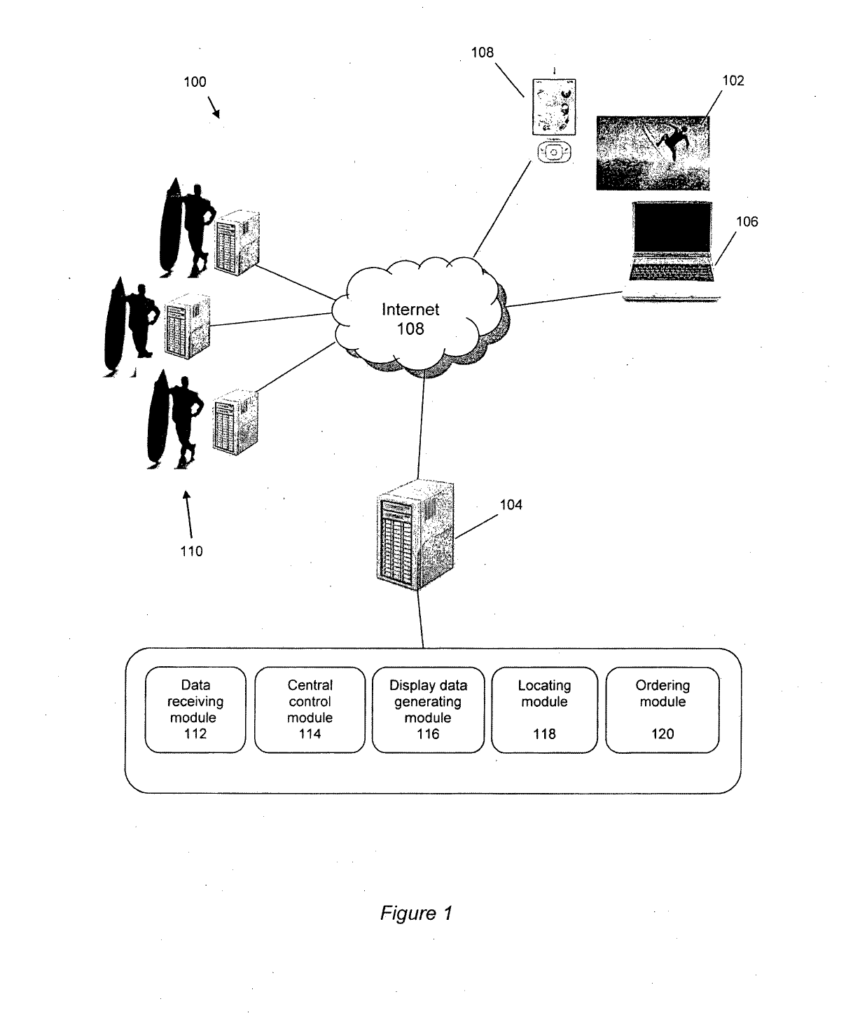

FIG. 1 shows a system 100 for selecting a surfboard for a surfer 102 (i.e. surfboard user or surfboard customer) in accordance with one embodiment of the present invention. The system 100 includes a control server 104 that executes a software product (being machine readable instructions) and hosts a surfboard web application by which customers 102 can select a suitable surfboard tailored to their needs and preferences.

The system 100 includes a customer's home PC or laptop 106 for accessing the surfboard website over the Internet 108. The system 100 also includes a customer's mobile internet device 108, such as a smart phone or tablet, for accessing the surfboard website over the Internet 108.

The system 100 also has connections, via the internet 108, with numerous surfboard manufacturers, factories, surfboard shapers, surf hardware/accessory companies and surfboard retailers 110. The surfboard manufacturers, factories and surfboard shapers 110 can upload information about their respective surfboard models onto the control server 104, as well as information about the available customisation options for each surfboard model. Once a customer 102 has ordered a surfboard, order information from the control server 104 such as the selected surfboard model, the customisation and accessories options are sent to the surfboard manufacturers, factories, shapers and/or surf hardware/accessory companies 110 so that the surfboard can be manufactured and delivered to the customer 102. The surfboard manufacturers, factories and surfboard shapers 110 may communicate with the control server 104 via their own servers and/or communication devices such as PCs, laptops, tablets, mobile internet devices, or the like.

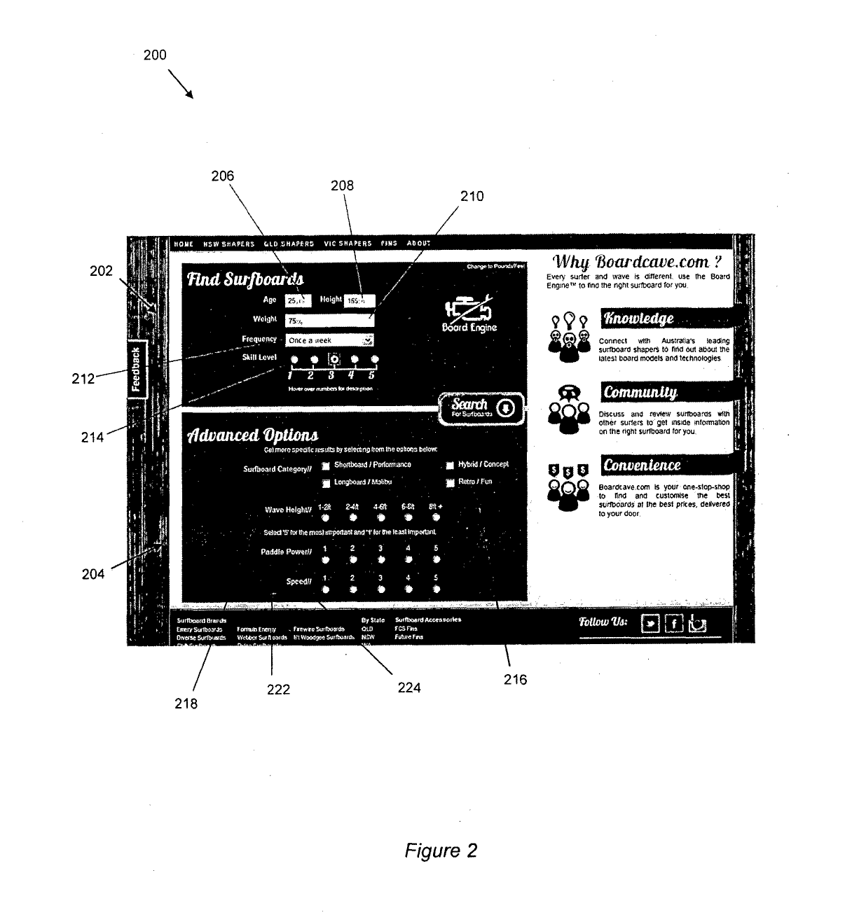

The control server 104 includes a data receiving module 112 (i.e. data receiving means) for receiving user information from the customer 102. Details in relation to the user information will be discussed further below in relation to FIG. 2.

The control server 104 also includes a central control module 114 (i.e. determining means) for determining a selection of surfboard models having a board size, shape and design suitable for the customer 102 based on the received user information. The surfboard size, shape and design are defined by the length, width, thickness and volume of a surfboard.

The control module 114 can automatically adjust the selection of suitable surfboard models presented to a customer 102 based on ratings and/or reviews of certain surfboard models submitted by other customers 102. For example, if one or more customers submit negative ratings or reviews in relation to a particular surfboard model, that particular surfboard model may no longer be recommended to other customers having similar user information. Conversely, if one or more customers submit positive ratings or reviews in relation to a particular surfboard model, that particular surfboard model may become more highly recommended to other customers having similar user information. This advantageously allows the system 100 to automatically and continuously refine and improve its accuracy in determining a list suitable surfboard models for a particular customer 102.

The control module 114 also generates the available customising and accessorising options for a selected surfboard model so that the customer 102 can further customise and accessorise their selected surfboard according to their personal requirements.

The control server 104 also includes a display data generating module 116 (i.e. display data generating means). The display data generating module 116 is configured to generate display data for displaying webpages on the customer's 102 display device (i.e. on the customer's PC/laptop 106 or mobile device 108 (such as a “smart” phone or tablet device). The display of the webpages is controlled by the control module 114 such that the webpages are displayed in sequence to assist the customer to select, customise and accessorise his/her surfboard. Details in relation to the webpages will be discussed further below in relation to FIGS. 2 to 8.

The control server 104 further includes a locating module 118 (i.e. locating means) for determining the location of the customer 102 and providing location specific information to the customer 102. For example, locating module 118 can provide information relating to surfboard retail outlets located in close proximity to the customer 102. Further details in relation to the locating module 118 will be discussed below.

Moreover, the control server 104 includes a ordering module 120 (i.e. ordering means) for compiling ordering information based on the customer's 102 surfboard selection, as well as the customer's customising and accessorising requirements and sending the ordering information to the relevant surfboard manufacturer, factory or shaper 110.

FIG. 2 illustrates a user input webpage 200 displaying user input fields. The user input fields are separated into basic input fields 202 and advanced input fields 204.

The basic input fields 202 include text entry fields 206, 208, 210 for receiving the customer's age, height and weight etc., respectively. The basic input fields 202 also include a drop down menu 212 to allow the customer to indicate how often he/she goes surfing from the options of ‘once a month/less’, ‘once a week’ or ‘everyday’.

The basic input fields 202 further include a rating scale 214 having ratings of between 1 to 5 to allow the customer 102 to select an appropriate skill level. To assist the customer 102 in selecting the most appropriate skill level, a text box containing a short description of each skill level is provided when the customer moves his/her cursor (i.e. hovers) over a particular rating. (This feature is not shown in FIG. 2.) For example, when the customer 102 hovers over rating 1, a text box containing the description “Never surfed, looking at starting” will appear. Similarly, when the customer 102 hovers over rating 2, the description “Learning to paddle, stand up, riding and turning in the white water” will appear. When the customer 102 hovers over rating 3, the description “Paddling out back, catching unbroken waves and surfing across the face” will appear. When the customer 102 hovers over rating 4, the description “comfortable surfing front and backside, performing cut backs, re-entries and floaters” will appear. When the customer 102 hovers over rating 5, the description “Perform all manoeuvres in all conditions (2 ft to 6 ft+), flawlessly” will appear.

In contrast to conventional “beginner”, “intermediate” and “advanced” scale ratings, the descriptions above allow the user 102 to more accurately select their skill level. The descriptions further allow retailers, manufacturers and shapers to more accurately categorise their surfboard models, and the central control module 114 to more accurately determine the surfboard models that are most suitable for the user 102.

The advanced input fields 204 include a multiple choice field 216 to allow the customer 102 to specify the desired surfboard category (i.e. shortboard/performance, longboard/malibu, hybrid/concept or retro/fun). The advanced input fields 218 also include a selection field 220 to allow the customer to indicate the height of the wave he/she is likely to be surfing (i.e. 1-2 ft, 2-4 ft, 4-6 ft, 6-8 ft, 8 ft+). The advanced input fields 218 further include rating scales 222, 224 having ratings of between 1 to 5 to allow the customer 102 to indicate the importance of paddle power and speed respectively in the performance of his/her surfboard.

In addition, the display data generating module 116 may generate data entry fields to allow a user to enter the wave type (i.e. beach break), wave height (i.e. 2-5 ft) and wave shape (i.e. hollow). The data display generating module 116 may further generate a map from which the customer 102 can select one or more surf locations in which the customer 102 is likely to surf. The central control module 114 can determine the typical wave height, type and shape based on the one or more selected surf locations.

The central control module 114 may further determine one or more other surf locations having similar waves to that specified by the user (either via data entry fields or the selection of a wave location on the map), and generate a list of surfboard models (and their respective manufacturers and shapers 110) suggested for the specified waves and selected surf locations. The data display generating module 116 generates display information to display the list of other surf locations and suggested surfboard models to the user 102.

Advantageously, the webpage 200 employs a combination of different types of entry fields (i.e. text box, drop down menu, multiple choice, etc) so that it is easy and convenient for the customer 102 to enter the necessary information. The basic input fields 202 require a minimum amount of information from the customer 102 so that the customer 102 can proceed to the next step quickly and efficiently. Further, the webpage 200 is presented in an uncluttered and aesthetically pleasing manner, which engages the customer 102 to enhance user experience.

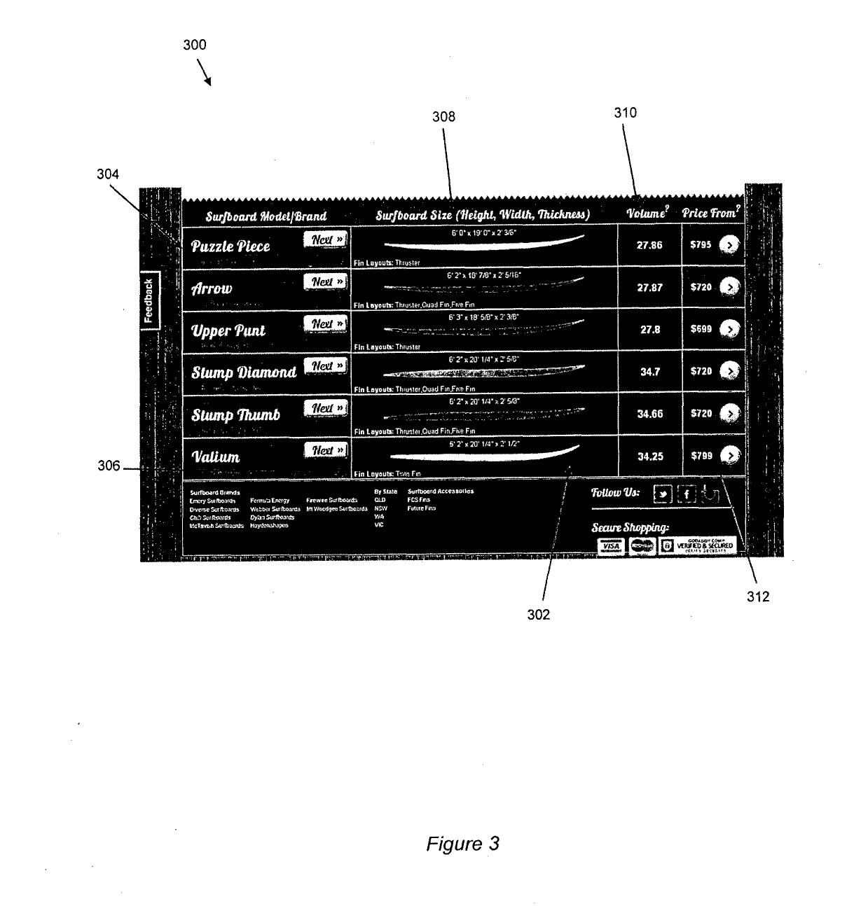

FIG. 3 illustrates a matrix of board results 300 which is generated based on the customer's 102 user information. The matrix of the surfboard results 300 includes multiple surfboard profile representations 302 corresponding to specific surfboard models, size, shape and design. These surfboard models each have dimensions (i.e. length, width, thickness and volume) which are considered suitable for the customer 102.

The profile representations 302 are a visually informative way of displaying the surfboard results 300 to the customer 102. Using the profile representations 302 is a compact way of displaying more results on one screen so that the customer can make easy comparisons between the surfboards quickly and effectively. The system 100 thereby better engages and guides the customer 102 to continue to proceed in using each step of the system 100.

The surfboard profile representations 302 may be ranked according to ranking factors such as the level of compatibility, performance, volume range, price range, length range, brand, quality, reviews, popularity, user ratings, eco ratings and availability, or the like.

The matrix of surfboard results 300 at least displays surfboard model and brand information 304, fin layout options 306, surfboard length, width and thickness information 308, surfboard volume information 310 and pricing information 312.

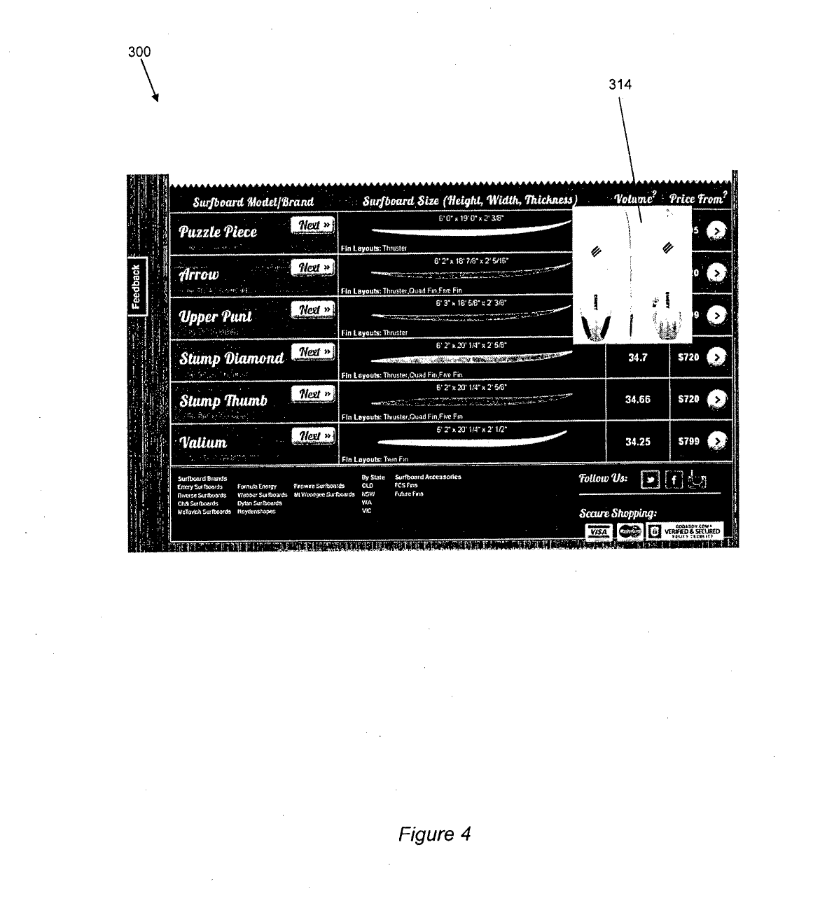

As shown in FIG. 4, other surfboard representations such as top, bottom and side (deck, bottom, rocker and concave) views of the corresponding surfboard model appears as a temporary image 314 when the customer 102 hovers over a particular profile representation.

Although not shown in FIGS. 3 and 4, the matrix of surfboard results 300 may also display representations of available off-the-rack surfboards which are ready for purchase. The available off-the-rack surfboards would also be generated based on the user information submitted by the customer 102.

If the customer 102 is happy with the matrix of surfboard results 300, the customer 102 may select a surfboard model and proceed to the next stage to customise the surfboard. The customer 102 may also select a surfboard model and save it in a shortlist for further consideration at a later stage. The customer 102 can select a number of surfboard models from different board results 300 and save them to his/her shortlist for comparison at any time.

Once the customer 102 has selected a surfboard model, the surfboard model can be customised using various customising options. The customising options would vary between surfboard models as not all customising options would be available to all surfboard models.

Alternatively, the customer's 102 can select an off-the-rack surfboard directly from the surfboard results 300 for purchasing without further customisation.

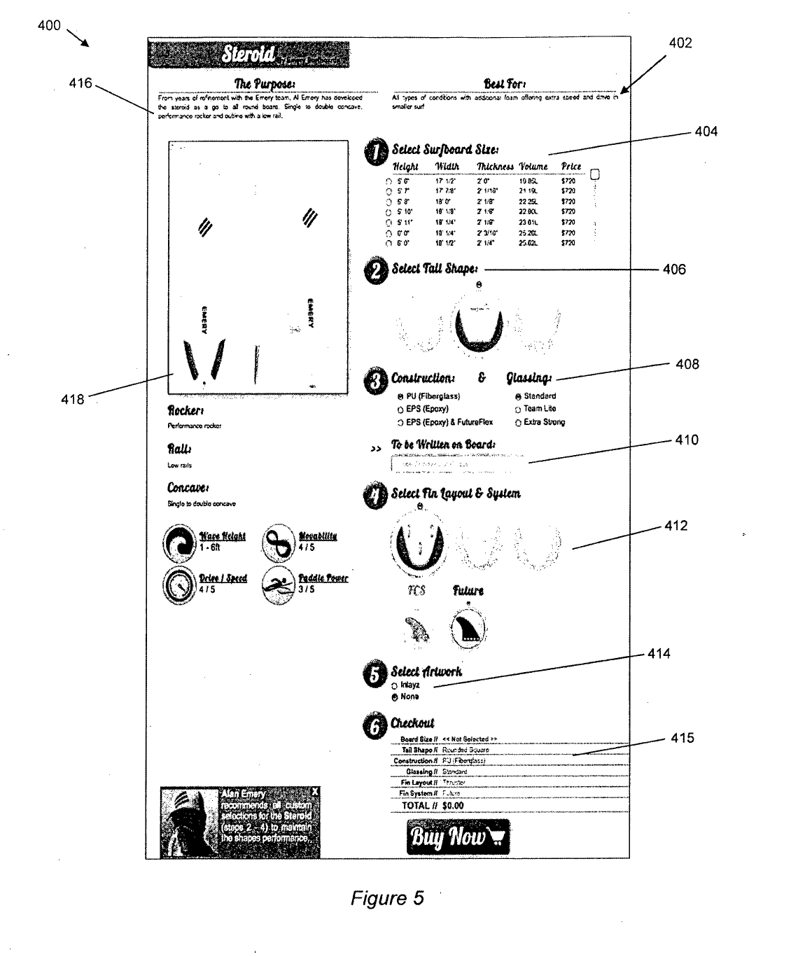

FIG. 5 shows a customisation webpage 400 displaying the available customising options 402 for a selected surfboard model “Arrow by Emery Surfboards”. The available customising options 402 would be the options which have been tried and tested by the manufacturer or shaper 110. The manufacturers or shapers can upload new customising options onto the control server 104 as they become available.

The customising options 402 include the size 404 of the surfboard, the tail shape 406 of the surfboard, the construction and glassing of the surfboard 408, a text message 410 which can be inscribed/printed on the surfboard, the fin layout and system 412 of the surfboard, and the artwork 414.

The customisation webpage 400 also displays a summary 415 of the selected customisation options 402 so that the customer 102 can easily keep track of his/her selected customisation options 402. A description or explanation of each customising option (not shown) appears in a temporary text box as the customer 102 hovers over each customising option similar to that described in relation to FIG. 2.

Moreover, the customisation webpage 400 includes a description of the selected surfboard model 416 and an image 418 of the selected surfboard model. The customer 102 can zoom in on the image 418 of the selected surfboard model. When the customer 102 hovers over a portion of the image 418, an enlarged view of that portion of the image 418 is displayed temporarily.

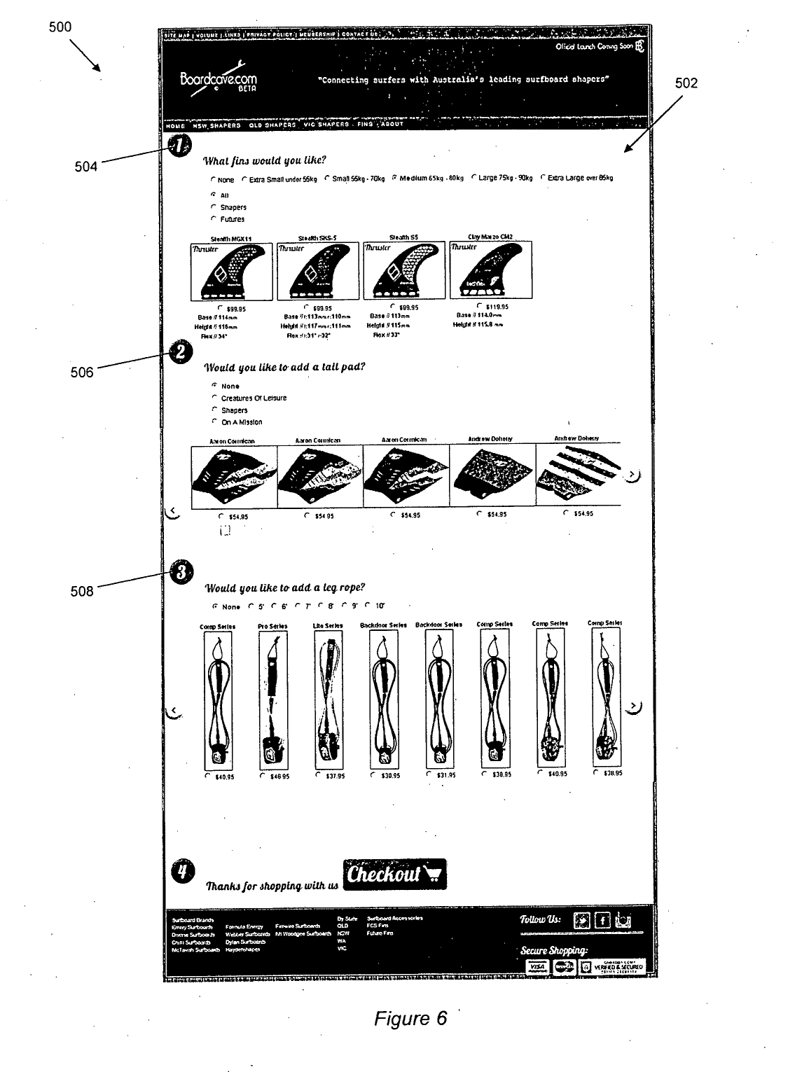

FIG. 6 is an accessories webpage 500 displaying a variety of accessories options 502. The accessories options 502 include fins 504, tail pads 506 and leg ropes 508. A description or explanation of each accessories option (not shown) appears in a temporary text box as the customer 102 hovers over each accessories option.

The available accessories options 502 are determined based on the customer's 102 user information and the selected surfboard model such that only suitable accessories options 502 are displayed. For example, if the user 102 is 80 kg, 185 cm and customises a 6′4″ surfboard with a thruster fin layout and FCS fin system. The system optimises the accessories options which are displayed to the user on the accessories webpage 500. In this example, the user 102 may need at least thruster fins with FCS plugs, a 6 ft board bag and a 6 ft leg rope. Conveniently, the user does not need to search through thousands of surf hardware products in order to purchase the accessories for a particular surfboard.

Again, the webpages 400, 500 have been designed to be easy to use. The use of icons throughout the webpages 400, 500 also helps to promote visual appeal and assist the user in understanding and visualising the different customisation and accessorising options.

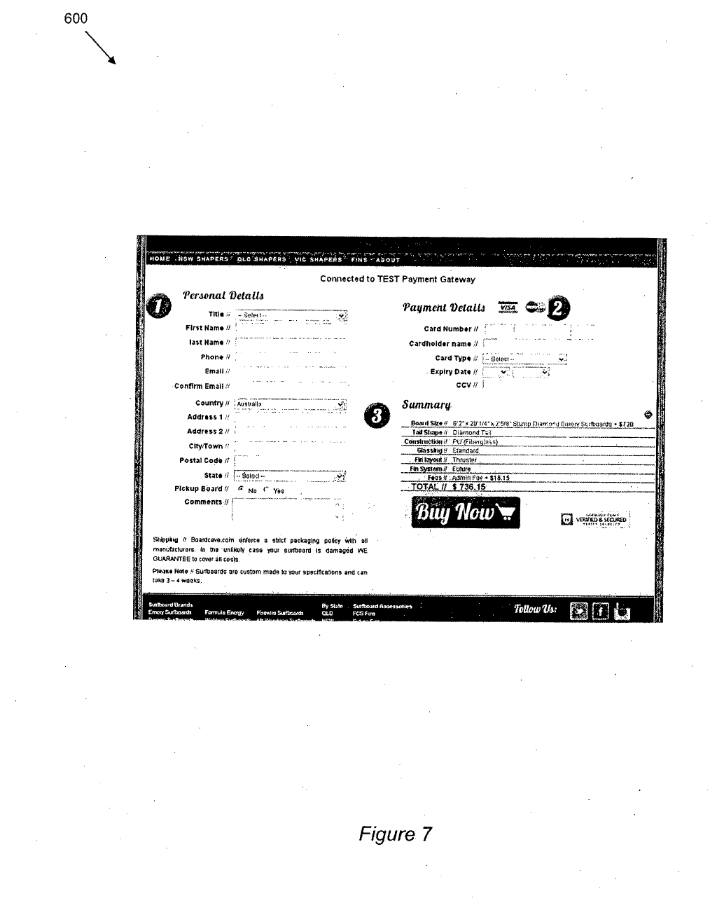

FIG. 7 is a customer and payment details webpage 600 to allow the customer 102 to enter the necessary personal and payment details to complete the surfboard order. If the customer's completed surfboard is already available as an off-the-rack surfboard from an existing manufacturer or retailer, or the customer selects an off-the-rack surfboard for direct purchase, the locating module 118 determines the position of the customer 102 and searches for nearby manufacturers/retailers/shapers having the off-the rack surfboard available for sale and can provide information about location and contact details of the nearby manufacturers/retailers/shapers to the customer 102.

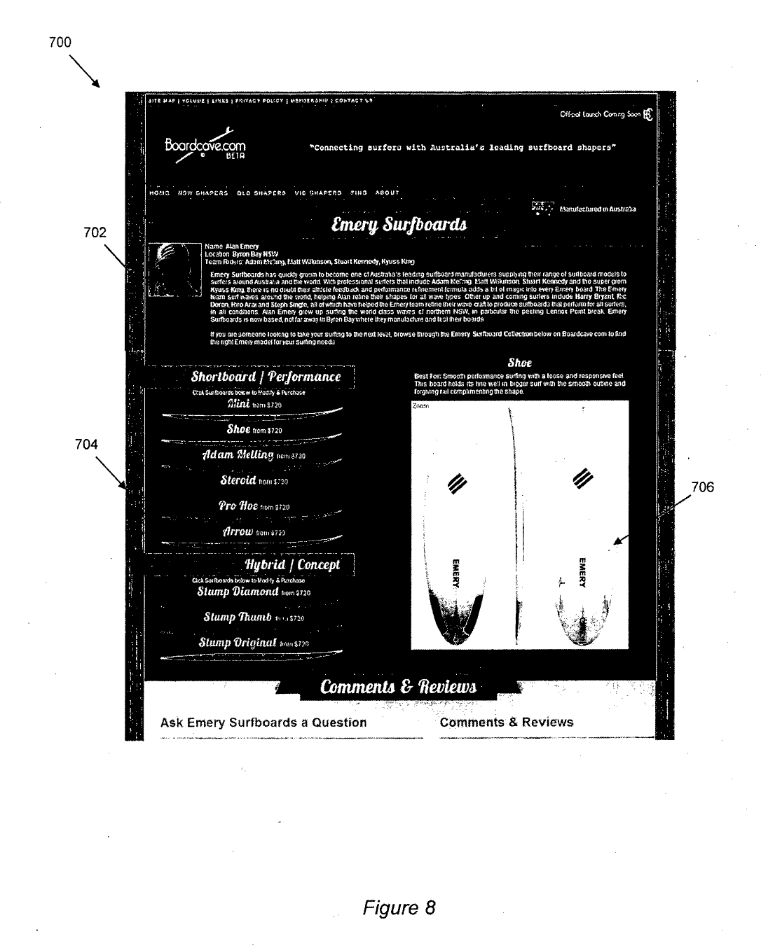

A customer 102 can also select a surfboard model directly from the surfboard manufacturer's or shaper's brand page (i.e. microsite). An example of a brand page 700 is shown in FIG. 8. The brand page 700 includes a brief description 702 of the surfboard manufacturer or shaper, profile representations 704 of the surfboard models provided by the surfboard manufacturer or shaper. As the customer 102 hovers over a specific profile representation, a three sided representation 706 of the corresponding surfboard model is presented. The information on the brand page 700 can be directly maintained and updated by the surfboard manufacturer or shaper 110. Once the customer 102 selects a surfboard model, the customer 102 can proceed to customise the surfboard model via the customisation webpage 400.

Whilst not specifically shown in FIG. 8, the brand page 700 also displays a selection of surfboard artwork provided by the manufacturer or shaper (i.e. tints, sprays, inlayz or the like). The system 100 also allows the manufacturers or shapers to upload videos and reply to comments on the brand page 700. Moreover, the customer 102 may also submit reviews or ratings via the brand page 700. The customer 102 may also be allowed to communicate with the manufacturer or shaper directly via email, SMS/instant messaging or live chat communication tools via the brand page 700 or the customisation web page 400.

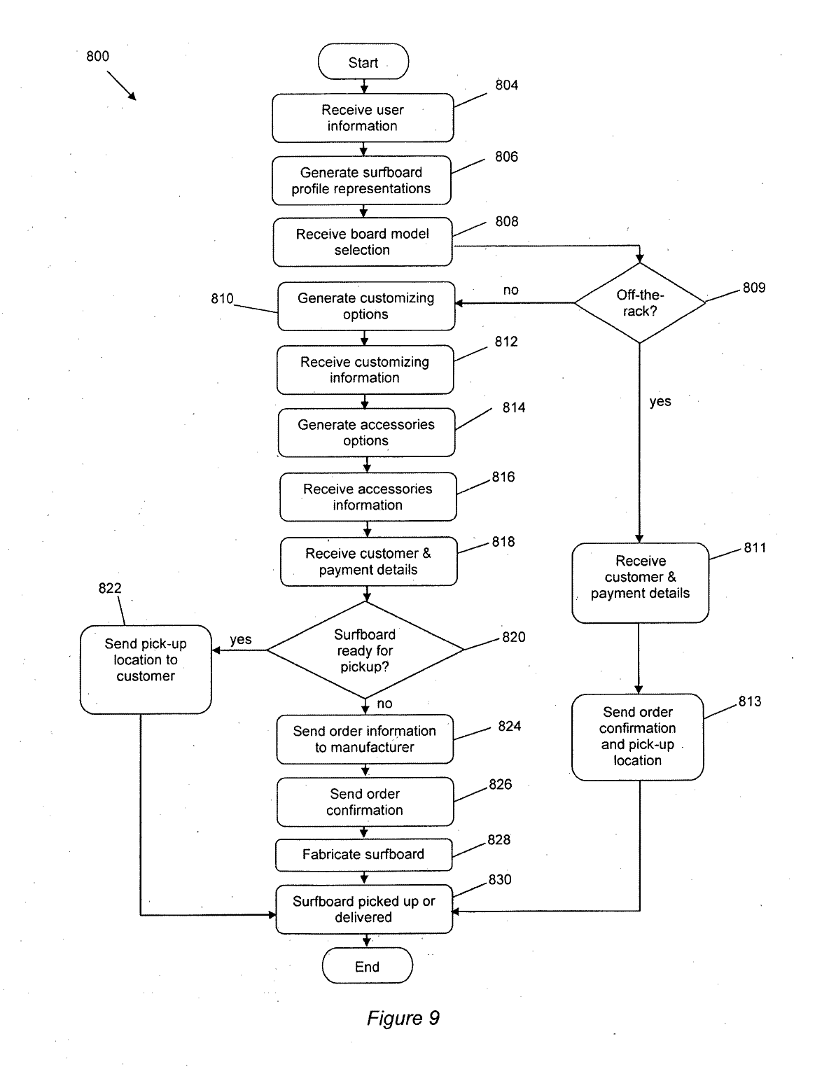

A method of selecting a surfboard 800 will now be described with reference to FIG. 9.

At step 804, the customer 102 visits the surfboard web application hosted by the control server 104 and enters his/her user information via the user input webpage 200 (refer to FIG. 2). The control server 104 receives user information, via the data receiving module 112, from the customer 102.

At step 806, the central control module 114 determines surfboard size information based on the received user information at step 804 and searches for relevant surfboard models in a control server database. The display data generating module 116 then generates display data to display profile representations of the relevant surfboard models (as shown in FIGS. 3 and 4).

At step 808, the customer 102 selects a desired surfboard model and the selection is received by the central control module 114 via the data receiving module 112.

At query step 809, if the selected surfboard model is available as an off-the-rack surfboard and the customer 102 wishes to purchase the off-the-rack surfboard, the method proceeds to step 811. If the selected surfboard model is not available as an off-the-rack surfboard, or if the customer 102 does not wish to purchase an off-the rack surfboard and wishes to continue customizing a surfboard the method proceeds to step 810.

At step 811, in response to receiving confirmation that the customer 102 has selected an off-the-rack surfboard at step 809, the central control module 114 instructs the display data generating module 116 to generate display data to display the customer and payment details webpage 600.

At step 813, once the payment has been completed successfully, the central control module sends an order confirmation to the customer 102. The central control module instructs the locating module 120 to determine the geographical position of the customer 102 and provides the pick-up location of the surfboard. The method then proceeds to step 830, which is described below.

At step 810, in response to receiving the selection at step 808, the central control module 114 instructs the display data generating module 116 to generate display data to display the customisation webpage 400 (refer to FIG. 5).

At step 812, the customer 102 selects the desired customising options and the selected options are received by the central control module 114 via the data receiving module 112.

At step 814, in response to receiving confirmation that the customer 102 has completed the customisation at step 812, the central control module 114 instructs the display data generating module 116 to generate display data to display the accessories webpage 500 (refer to FIG. 6).

At step 816, the customer 102 selects the desired accessorising options and the selected options are received by the central control module 114 via the data receiving module 112.

At step 818, in response to receiving confirmation that the customer 102 has completed accessorising the surfboard at step 816, the central control module 114 instructs the display data generating module 116 to generate display data to display the customer and payment details webpage 600.

At step 820, once the necessary information has been received by the central control module 114 and the payment has been completed successfully, the central control module instructs the locating module 120 to determine the geographical position of the customer 102 and conducts a search to determine whether a surfboard having the same specification as the surfboard ordered by the customer 102 is available for pick-up from a local dealer as a ready-made off-the-rack surfboard. If such an off-the-rack surfboard is available for pick-up, the method proceeds to step 822, if not, the method proceeds to step 824.

At step 822, the locating module 120 sends information to the customer 102 relating to the location of the dealer from which the surfboard may be picked up. The customer 102 may elect to pick up the surfboard from that dealer or have the surfboard delivered to a specified postal address.

At step 824, the central control module 114 instructs the ordering module 120 to compile the ordering information based on the information received via the data receiving module at steps 808, 812, 816 and 818 and sends the order information to the surfboard manufacturers, warehouses, factories and/or shapers 110 so that an off-the-rack surfboard can be located, or a surfboard can be made according to the order information. The order information can also include accessories information in relation to the accessories selected by the customer 102. The accessories information can be sent to surf hardware suppliers that may be associated with, or separate to the surfboard manufacturers, factories and shapers 110 so that the surf hardware suppliers can provide the accessories selected by the customer 102.

At step 826, the central control module sends an order confirmation to the customer 102.

At step 828, the relevant manufacturer, factory or shaper 110 makes a surfboard according to the order information sent from the control server 104.

At step 830, the customer 830 can either pick-up the surfboard directly from the manufacturer, factory or shaper 110 or have the surfboard delivered to a specified postal address.

In an alternative embodiment, the customer 102 selects a surfboard model from a brand page 700 and bypasses steps 804 and 806. Once a desired surfboard model is selected from the brand page 700, the customer 102 proceeds with the rest of the method 800 from step 808 onwards.

In another embodiment, at steps 818 and 820, the customer 102 and payment details webpage 600 may be displayed after the local dealers' information is sent to the customer 102.

In a further embodiment, the display data generating module 116 may generate display data to display 3D representations of the surfboard models. In addition, the customer 102 may be able to customise a 3D representation of a selected surfboard model so that the customer 102 can more effectively visualise and compare the different surfboard options and customisation changes. The 3D surfboard model may be interactive, for example, the customer 102 may freely rotate, enlarge and move the 3D representation.

Advantageously, a customer 102 with little surfing or interne experience can easily navigate through the intuitive surfboard web application as described above. The surfboard representations, stylised icons, the combination of different simple data entry fields, and the temporary text explanation of the different options and entry fields, allow any customer 102 to easily understand the functionality of the different surfboard models and options so that the customer 102 can easily select a suitable surfboard having personalised features.

In a further embodiment, the manufacturer/shaper 110 may conduct a check of the received ordering information to ensure that there are no anomalies. The manufacturer/shaper 110 may contact the customer 102 to recommend further customisation adjustments to confirm the ordering information, or if any anomalies are discovered so that the customer 102 has an opportunity to modify or correct a feature of the surfboard.

In some embodiments, the system 100 allows surfboard manufacturers and/or shapers 110 to enter and update the estimated time required to manufacture, pack, dispatch and deliver a particular surfboard (e.g. the lead time). Alternatively, the system 100 can automatically provide an estimated lead time based on information provided by the surfboard manufacturers and/or shapers 110. In these embodiments, the customer 102 can select a surfboard manufacturer and/or shaper 110 based on an estimated lead-time (e.g. 2 weeks, 4 weeks). The system 100 can also allow the customer 102 to track his/her order, and/or receive regular updates at each predetermined stage of manufacturing, packaging, dispatch and delivery.

In some embodiments, the system 100 sends the user information and the corresponding user selected surfboard model, size and design to the surfboard manufacturers and/or shapers 110 for review. The system 100 can allow the surfboard manufacturers and/or shapers 110 to select a “confirm” option within the system 100 to indicate that selected surfboard specifications (e.g. model, size and design) are suitable for the customer 102 based on the user information.

In some embodiments, the system 100 allows a customer 102 to adjust the size of each surfboard determined by the determination means of the system 100 so as to cater to different needs and requirements.

In some embodiments, the system 100 allows the customer 102 (e.g. experienced surfer) to search and filter surfboards based on surfboard specifications such as volume/literage.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for selecting a surfboard for a user, the system including
data receiving means for receiving user information from the user,
determining means for determining at least surfboard size information based on the received user information, and
display data generating means being configured to generate display data for displaying one or more surfboard representations corresponding to the determined surfboard size information for selection by the user.

2. A system of claim 1, wherein the one or more surfboard representations includes one or more surfboard profile representations.

3. A system of claim 1, wherein the user information includes personal information including any one or more of:
the user's weight, height, feet size, age, fitness level, skill level, surf conditions, surfing experience, surfing frequency, surfing location, and/or wave type or shape.

4. A system of claim 1, wherein the user information includes board information including any one or more of:
board volume, length, width, thickness, nose width, tail width, centre of buoyancy, surface area, stability, paddle power, speed, materials, construction method, manufacturer/brand, surfboard shaper location, tail shape, fin layout, fin type, surfboard type, wave height, wave shape, rocker, concave, rails, maneuverability, artwork, minimum/maximum length, minimum/maximum volume, minimum/maximum width, minimum/maximum price, glassing, and/or foam density.

5. The system of claim 1, wherein the user information includes
mandatory information in which the user must provide for the determination means to determine the board size information, and
optional information in which the user can choose to provide for consideration by the determining means.

6. The system of claim 1, wherein the determining means further determines surfboard shape and surfboard design information based on the received user information.

7. The system of claim 6, wherein the board size, shape and design information includes any one or more of: board length, width, thickness and volume, nose width, tail width, centre of buoyancy, surface area, stability, paddle power, speed, materials, construction method, manufacturer/shaper/brand, surfboard shaper location, tail shape, fin layout, fin type, surfboard type, price, wave height, wave shape, rocker, concave, rails, maneuverability, artwork, glassing and foam density.

8. The system of claim 1, wherein the determining means determines a list of suitable surfboard models for the user based on the user information.

9. The system of claim 8, wherein the list of suitable surfboard models is adjustable based on user reviews and/or ratings.

10. The system of claim 1, wherein the one or more board representations are ranked according to ranking factors, the ranking factors including any one or more of: level of compatibility, performance, volume range, price range, length range, brand, quality, reviews, popularity, user ratings, eco ratings and availability.

11. The system of claim 1, wherein the display data generating means is configured to generate display data for displaying information including any one or more of:
board length, width, thickness, volume, fin layout options, prices, board shaper, board model, available stock, reviews, surfboard category, surfboard image and shape outline preview.

12. The system of claim 1, further including
locating means for locating the user and providing information to the user in relation to one or more surfboard retailers located close by having a selected surfboard available for purchase.

13. The system of claim 1, wherein the system allows surfboard retailers, manufacturers and/or shapers to directly upload and maintain surfboard information in relation to their surfboard models.

14. The system of claim 13, wherein the determining means determines a list of suitable surfboard models for a user based on the surfboard information.

15. The system of claim 1, wherein the data receiving means receives a user selection of a surfboard for customisation.

16. The system of claim 1, wherein in response to the user selection of the surfboard for customisation, the display data generating means generates display data for displaying customisation options.

17. The system of claim 16, wherein the customisation options includes any one or more of:
size options of the board, tail shape options, construction and glassing options, fin layout options, fin type options, art work options, printed or inscribed text.

18. The system of claim 16 or 17, wherein the system is configured to enable the user to manually adjust the length, width, thickness, tail shape, nose width, tail width, rail shape, concave and/or rocker of a selected surfboard using the customisation options.

19. The system of claim 1, wherein the display data generating means further generates display data for displaying surfboard accessories options, the surfboard accessories options including any one or more of: surfboard fin options, tail pad options and leg rope options, surfboard bag options.

20. The system of claim 19, wherein the display data generating means further generates display data based on the user information for displaying the surfboard accessories options.

21. The system of claim 1, further including
ordering means for compiling ordering information using one or more of: a user selected surfboard, user selected customisation options and user selected accessories options,
the ordering means being configured to send the ordering information to a manufacturer or surfboard shaper, surf hardware company or retail partner.

22. A system for selecting a surfboard for a user, the system including
data receiving means for receiving user information from the user, and
determining means for determining at least surfboard size information based on the received user information.

23. A method for selecting a surfboard for a user, the method including
receiving, with computational means, user information from the user, and
determining at least surfboard size information based on the received user information.

24. A method of selecting a surfboard for a user, the method including,
receiving, with computational means, user information from the user, and
recommending one or more surfboards based on the user information.

25. A method of claim 23, including
displaying a surfboard summary of each surfboard recommendation.
